(19) United States
(12) Patent Application Publication
(10) Pub. No.: US 2004/0264694 A1
(43) Pub. Date: Dec. 30, 2004

(54) High-density optical disc, method for recording and reproducing encrypted data thereon

(76) Inventors: Jin Yong Kim, Kyunggi-do (KR); Sang Woon Suh, Seoul (KR)

Correspondence Address: HARNESS, DICKEY & PIERCE, P.L.C., P.O. BOX 8910, RESTON, VA, 20195, US

(21) Appl. No.: 10/485,912

(22) PCT Filed: Jun. 5, 2003
(86) PCT No.: PCT/KR03/01109

(30) Foreign Application Priority Data
Jun. 5, 2002 (KR) 10-2002-0331744

(51) Int. Cl. H04N 7/167

(52) U.S. Cl. 380/200

(57) ABSTRACT

A high-density optical disc, a method for encrypting data and recording the encrypted data thereon, and a method for reproducing the encrypted data recorded thereon. A high-density optical disc such as a Blu-ray disc-read only memory (BD-ROM) has a helical track formed from the disc's outer periphery to the disc's inner periphery. An order of recording data frames on the BD-ROM is diametrically opposite to that of a rewritable optical disc such as a Blu-ray disc rewritable (BD-RE). Data can be encrypted using disc radius information or an address unit (AU) number contained in an AU and then the encrypted data is recorded on the high-density optical disc. Thus, a user holding the optical disc apparatus such as the BD-RE player can be prevented from unlawfully copying data of the BD-ROM to the BD-RE and unlawfully reproducing the copied data.

### 1. TECHNICAL FIELD

The present invention relates to a high-density optical disc from which data can be reproduced, a method for encrypting data and recording the encrypted data thereon, and a method for reproducing the encrypted data recorded thereon.

### 2. BACKGROUND ART

Recently, large-capacity digital versatile discs (DVDs) capable of permanently storing high-quality video and audio in comparison with compact discs (CDs) have been developed, commercialized and supplied. Types of the DVDs include a DVD-read only memory (DVD-ROM), a write once DVD recordable (DVD-R), a DVD-random access memory (DVD-RAM) or DVD rewritable (DVD-RW), etc.

Standardization of a high-density rewritable optical disc, e.g., a Blu-ray disc rewritable (BD-RE) capable of recording high-density data, is ongoing. The BD-RE will be described in detail.

FIG. 1 shows recording unit blocks (RUBs) of a high-density rewritable optical disc, e.g., a Blu-ray disc rewritable (BD-RE). As shown in FIG. 1, a single RUB consisting of a run-in area, physical cluster area and run-out area or a sequence of RUBs consisting of run-in areas, physical cluster areas, run-out areas and the third guard area (Guard_{—}3) located in a tail of the sequence of RUBs can be recorded in a BD-RE 100. In the sequence of the RUBs, each RUB consisting of the run-in area, physical cluster area and run-out area can be repeated twice or more.

As shown in FIG. 2, the physical cluster area can contain a data stream associated with video data of moving pictures and audio data, frame synchronous information, a long distance error correction (LDC) code, a burst indicator sub-code (BIS) and an address unit (AU).

The LDC code and BIS are recorded on the basis of well-known Reed-Solomon code words for error correction. The AU is used for correctly searching for a position of recorded data.

The physical cluster area contains 16 AUs (AU 0˜AU 15). An AU of 9 bytes includes an address unit (AU) number, flag bits, etc. The flag bits are reserved and set to “00h”.

As shown in FIG. 4, the AU numbers are linked to physical sector numbers and also linked to physical address in pre-groove (ADIP) addresses. The AU number is useful as reference information in searching for the position of recorded data.

Thus, an optical disc apparatus such as a BD-RE recorder, etc. reads and confirms the physical sector numbers and physical ADIP addresses linked to the AU numbers. Then, the optical disc apparatus searches for a video and audio data stream recorded in the physical cluster area, and then reads the searched data stream. Then, the optical disc apparatus performs a moving picture experts group (MPEG) decoding operation to reproduce original video and audio signals.

Recently, it has been expected that the high-density optical disc, e.g. the BD-ROM, corresponding to the high-density rewritable optical disc will be developed. The high-density optical disc such as the BD-ROM must be able to prevent unauthorized or unlawful usage. However, there is not yet provided a method for effectively preventing the unauthorized or unlawful usage.

### 3. DISCLOSURE OF INVENTION

Therefore, it is an object of the present invention to provide a high-density optical disc, a method for encrypting data and recording the encrypted data thereon, and a method for reproducing the encrypted data recorded thereon, which can encrypt data so that unauthorized or unlawful usage can be prevented, and record and reproduce the encrypted data.

In accordance with one aspect of the present invention, the above and other objects can be accomplished by the provision of a high-density optical disc, wherein data is encrypted, and the encrypted data is recorded according to a discontinuous recording format, while the encrypted data being recorded from the disc's outer periphery to the disc's inner periphery on a track of the disc.

In accordance with another aspect of the present invention, there is provided a method for encrypting data and recording the encrypted data on a high-density optical disc, comprising the steps of: (a) encrypting data on the basis of disc radius information or an address unit number recorded on the high-density optical disc; and (b) recording the encrypted data from the disc's outer periphery to the disc's inner periphery on a track of the disc.

In accordance with yet another aspect of the present invention, there is provided a method for reproducing encrypted data recorded on a high-density optical disc, comprising the steps of: (a) searching for and reading disc radius information or an address unit number recorded on the high-density optical disc; (b) decrypting encrypted data on the basis of the disc radius information or address unit number recorded on the high-density optical disc; and (c) decoding the decrypted data to original signal, and reproducing the original signal.

### 4. BRIEF DESCRIPTION OF DRAWINGS

The accompanying drawings, which are included to provide a further understanding of the invention, illustrate the preferred embodiments of the invention, and together with the description, serve to explain the principles of the present invention.

FIG. 1 is a view illustrating recording unit blocks (RUBs) of a Blu-ray disc rewritable (BD-RE);

FIG. 2 is a table illustrating data recorded in a physical cluster area of the BD-RE;

FIG. 3 is a view illustrating address units (AUs) recorded in the physical cluster area;

FIG. 4 is a view illustrating relations between a physical sector number, an address unit number and a physical address in pre-groove (ADIP) address associated with the BD-RE;

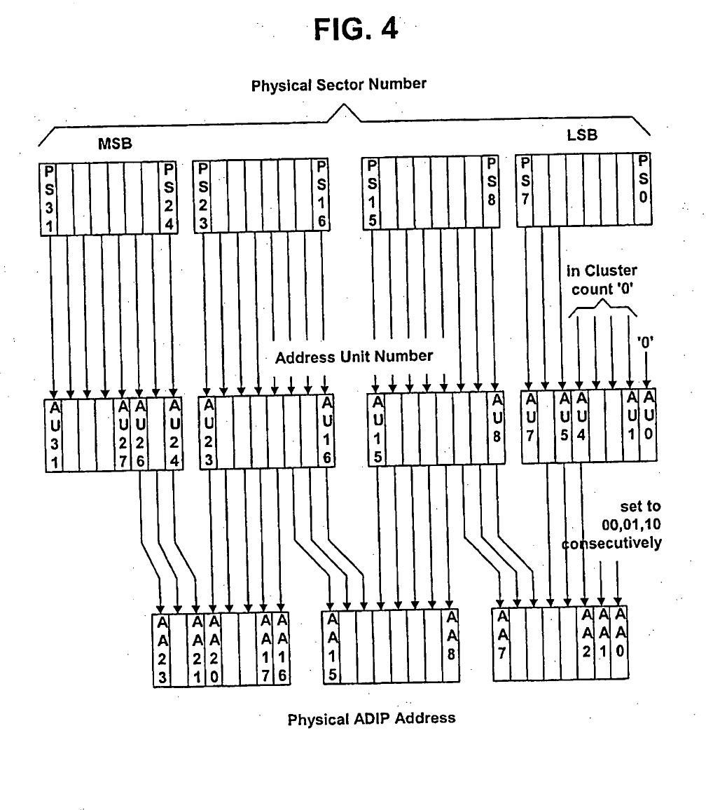

FIG. 5 is a view illustrating a helical track of a Blu-ray disc-read only memory (BD-ROM) in accordance with an embodiment of the present invention;

FIG. 6 is a view illustrating a state where radius information is recorded in an address unit (AU) of the BD-ROM in accordance with an embodiment of the present invention;

FIG. 7 is a view illustrating the relationship between an encoding system to which an encryption and recording method is applied, and the BD-ROM in accordance with an embodiment of the present invention;

FIG. 8 is a view illustrating the configuration of an optical disc apparatus to which an encrypted data reproduction method is applied in accordance with an embodiment of the present invention; and

FIG. 9 is a flowchart illustrating the encrypted data reproduction method in accordance with an embodiment of the present invention.

Features, elements, and aspects of the invention that are referenced by the same numerals in different figures represent the same, equivalent, or similar features, elements, or aspects in accordance with one or more embodiments.

### 5. MODES FOR CARRYING OUT THE INVENTION

A high-density optical disc, a method for encrypting data and recording the encrypted data thereon, and a method for reproducing the encrypted data recorded thereon in accordance with preferred embodiments of the present invention will be described in detail with reference to the annexed drawings.

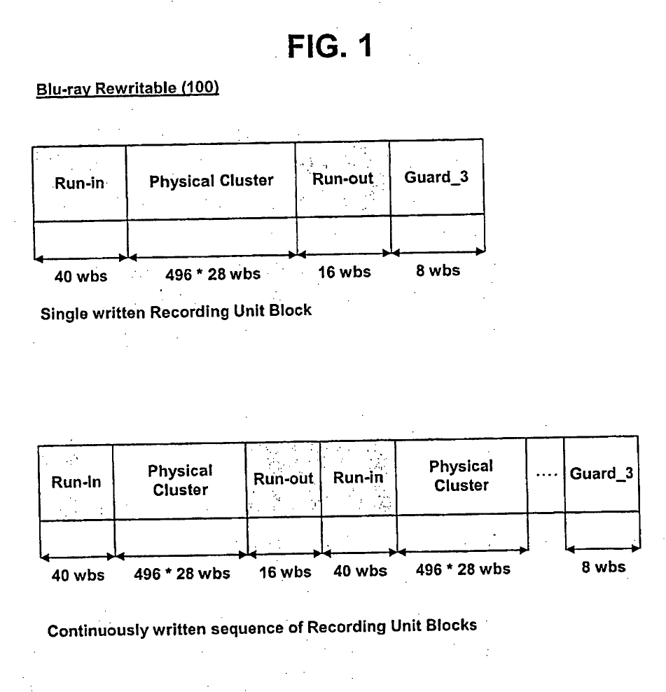

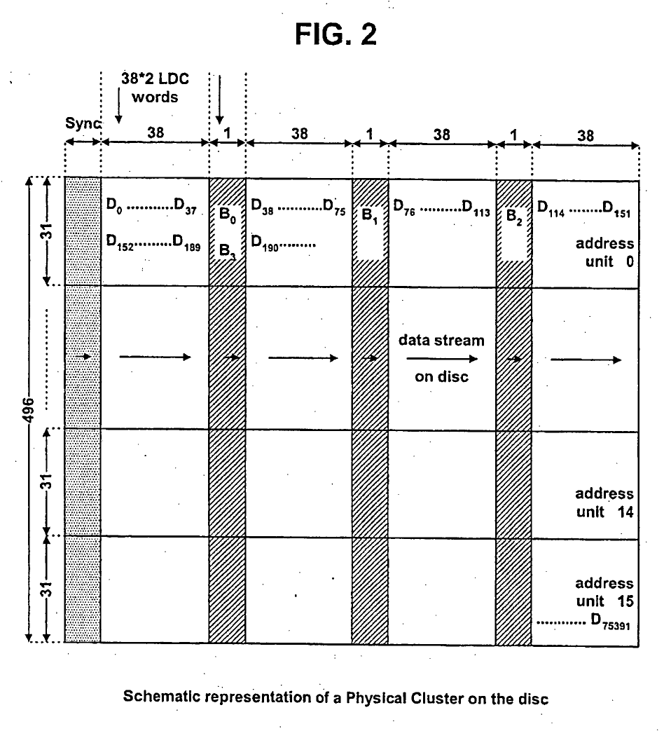

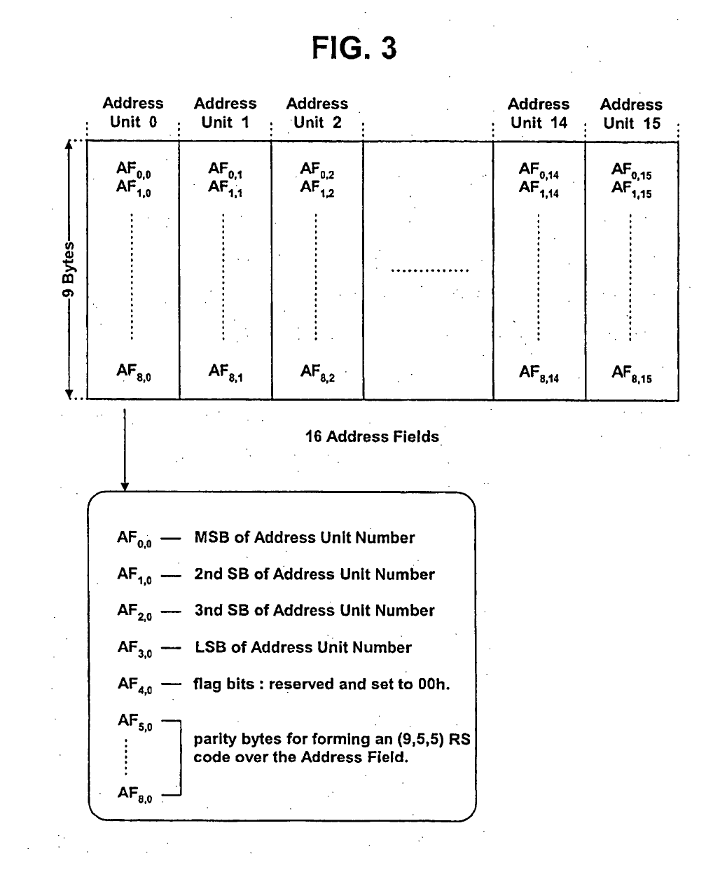

First, as a Blu-ray disc rewritable (BD-RE) 100 in which video data of a moving picture and audio data are discontinuously recorded as shown in FIGS. 1 to 3, the high-density optical disc, e.g., a Blu-ray disc-read only memory (BD-ROM), can record at least one RUB consisting of a run-in area, a physical cluster area, a run-out area and the third guard area (Guard_{—}3). For reference, names of the above-described areas can be changed and designated by other names.

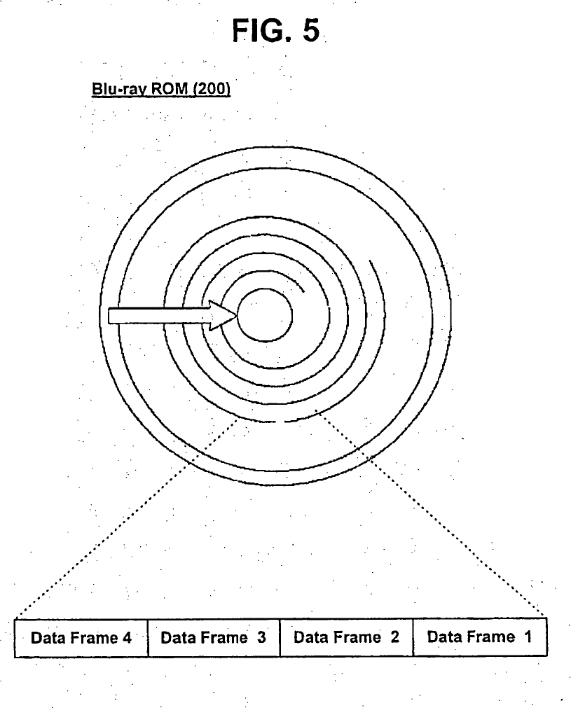

As shown in FIG. 5, the disc of a BD-ROM 200 in accordance with an embodiment of the present invention has a helical track formed from the disc's outer periphery to the disc's inner periphery. Moreover, on the helical track of the BD-ROM 200, video and audio data frames are sequentially recorded from the outer periphery to the inner periphery.

On the other hand, a disc of the BD-RE 100 has a helical track formed from the disc's inner periphery to the disc's outer periphery. On the helical track of the BD-RE 100, video and audio data frames are sequentially recorded from the inner periphery to the outer periphery. As a result, the BD-ROM 200 and BD-RE 100 have different helical track patterns. An order of recording the data frames on the BD-RE 100 is diametrically opposite to that of the BD-ROM 200.

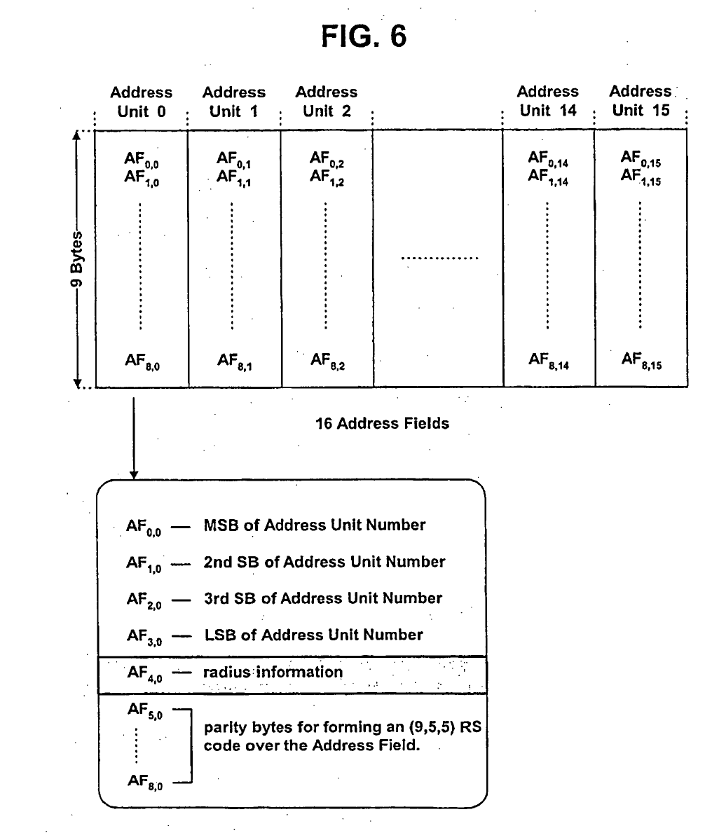

The AU recorded in the physical cluster area can contain disc radius information used for detecting a distance between a criterion of the outer periphery of the BD-ROM 200 and a corresponding position on the disc. For example, the disc radius information can be recorded by the 5^{th} byte of the AU as shown in FIG. 6.

Therefore, in accordance with the embodiment of the present invention, an order of recording data frames on the BD-ROM 200 is diametrically opposite to that of the BD-RE 100, and the disc radius information based on the criteria of the outer periphery of the BD-ROM 200 is recorded in the AU.

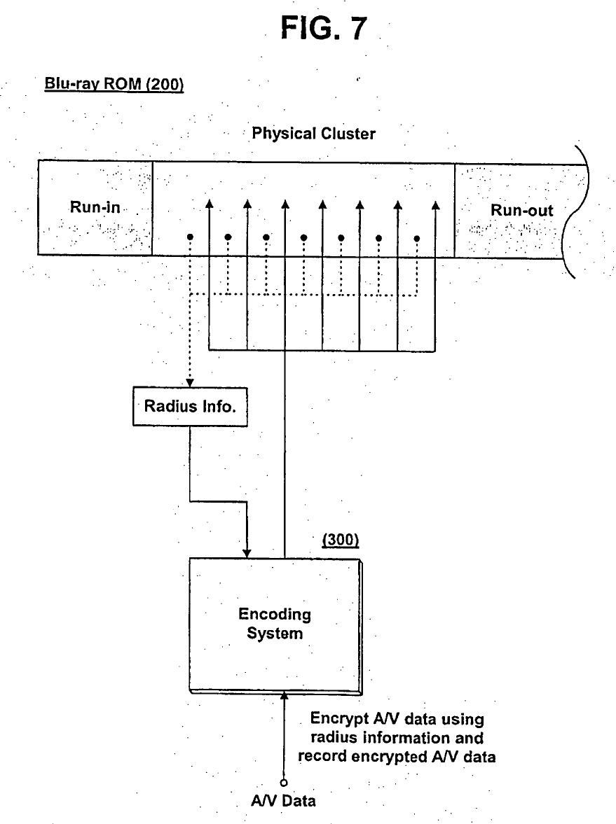

Encrypted audio/video (A/V) data are recorded in the physical cluster area of the BD-ROM 200 so that unlawful usage can be prevented. For example, as shown in FIG. 7, an encoding system 300, recording encrypted data in the physical cluster area of the BD-ROM 200, encrypts A/V data using the disc radius information or AU numbers contained and recorded in the AU, and then records the encrypted A/V data in the physical cluster area.

For reference, the encoding system 300 can selectively use any conventional encryption processing method such as an encryption method, interleaving method, scrambling method, or etc.

As described above, the order of recording data frames on the BD-ROM is diametrically opposite to that of recording the data frames on the BD-RE, and an encryption and recording operation for the BD-ROM is performed using the disc radius information or AU numbers contained and recorded in the AUs, such that the unauthorized or unlawful usage of the BD-ROM can be prevented.

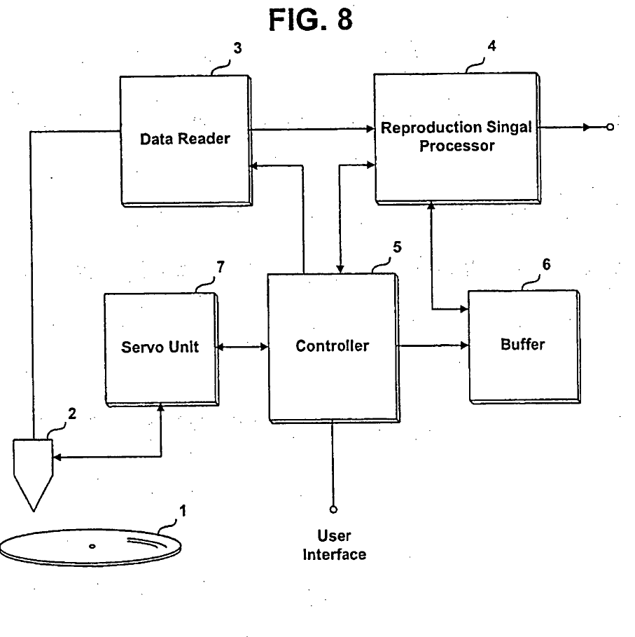

FIG. 8 is a view illustrating the configuration of an optical disc apparatus for which an encrypted data reproduction method is applied in accordance with an embodiment of the present invention. An optical disc apparatus, e.g., a BD-ROM player, includes an optical pick-up 2 and data reader 3 for reading encrypted A/V data recorded from the disc's outer periphery to the disc's inner periphery on a BD-ROM 1; and a reproduction signal processor 4 for decrypting the encrypted A/V data using disc radius information or AU numbers recorded on the BD-ROM 1, decoding the A/V data to original video and audio signals, and processing the video and audio signals to be reproduced.

The BD-ROM player further includes a controller 5 for controlling a reproduction signal processing operation; a buffer 6 for temporarily storing data needed for performing the reproduction signal processing operation; a servo unit 7 for performing a servo control operation so that the data can be read while the optical pick-up 2 is moved from the disc's outer periphery to the disc's inner periphery, etc.

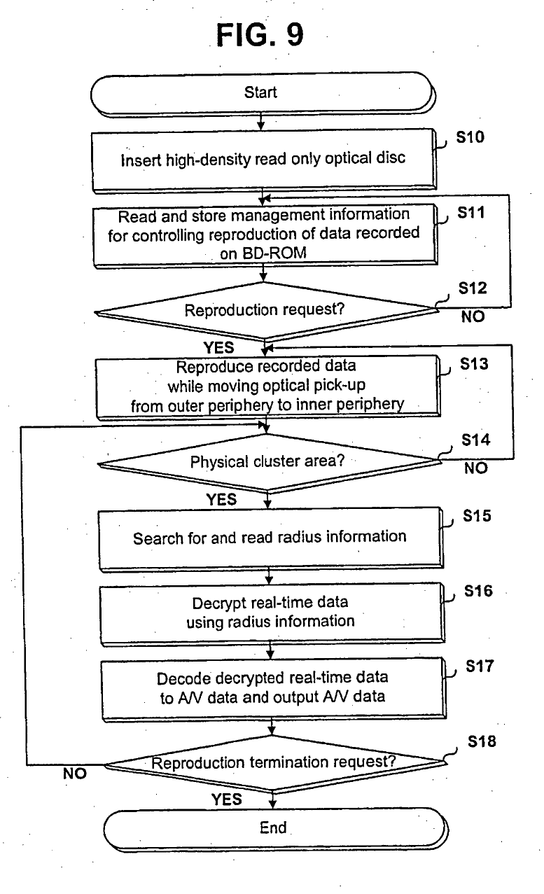

FIG. 9 is a flowchart illustrating the encrypted data reproduction method in accordance with an embodiment of the present invention. When the BD-ROM 1, on which a helical track is formed from the disc's outer periphery to the disc's inner periphery and encrypted A/V data is discontinuously recorded as shown in FIGS. 5 to 7, is inserted and loaded at step S10, the controller 5 searches for and confirms a lead-in area contained in the BD-ROM 1. The lead-in area can be formed on the innermost or outermost area of the disc. The optical disc apparatus reads management information recorded in the lead-in area, i.e., management information for controlling the reproduction of data recorded on the BD-ROM 1, and then stores the read management information in an internal memory (not shown) at step S11.

When the reproduction operation is requested from the user at step S12, the controller 5 performs a sequence of reproduction operations for reading and reproducing the recorded data while moving the optical pick-up 2 from the disc's outer periphery to the disc's inner periphery after moving the optical pick-up 2 to a position where real-time data such as A/V data was first recorded at step S13.

Where the data contained in a physical cluster area of the disc is reproduced while the reproduction operation is performed, disc radius information within an AU contained and recorded in the physical cluster area is read at step S15. Real-time data, i.e., encrypted A/V data, is decrypted to original A/V data using the read disc radius information at step S16. The decryption processing operation uses a decryption method corresponding to an encryption method, an interleaving method, a scrambling method, or etc. used in the above-described encryption processing operation.

At step S18, the controller 5 controls an operation of the reproduction signal processor 4 so that a sequence of reproduction signal processing operations for reproducing the decrypted A/V data to output original video and audio signals through an MPEG decoding operation can be appropriately performed. When a reproduction termination request is received according to the user's key input at step S19, the reproduction operation is terminated.

After AU numbers are searched for and read in place of the disc radius information, or the disc radius information and the AU numbers all are searched for and read, the controller 5 can perform the decryption processing operation using the searched AU numbers or/and radius information.

As described above, the encrypted data is decrypted using the radius information or AU numbers contained and recorded in the physical cluster area of the BD-ROM, and the decrypted data is reproduced. Thus, a user holding the optical disc apparatus such as the BD-RE player can be prevented from unlawfully copying data of the BD-ROM to the BD-RE and unlawfully reproducing the copied data.

For reference, the above-described method for encrypting and decrypting data using the disc radius information or AU numbers can be applied to the rewritable optical disc such as the BD-RE.

The preferred embodiments of the present invention have been disclosed for illustrative purposes. Those skilled in the art can readily understand that the present invention can be applied for other high-density optical discs as well as the BD-ROM. Further, those skilled in the art will appreciate that various modifications, additions and substitutions are possible, without departing from the scope and spirit of the invention as disclosed in the accompanying claims.

As apparent from the above description, the present invention provides a high-density optical disc, a method for encrypting data and recording the encrypted data thereon, and a method for reproducing the encrypted data recorded thereon, which can effectively prevent a user holding an optical disc apparatus such as a BD-RE recorder, etc. from unlawfully copying data recorded on the high-density optical disc and reproducing the copied data.

1. A high-density optical disc,
wherein data is encrypted, and the encrypted data is recorded according to a discontinuous recording format, while the encrypted data being recorded from the disc's outer periphery to the disc's inner periphery on a track of the disc.

2. The high-density optical disc as set forth in claim 1, wherein disc radius information indicating a distance between the disc's outer periphery and a corresponding position is contained and recorded in an address unit of a data recording area in which the data is recorded.

3. The high-density optical disc as set forth in claim 2, wherein the data is encrypted on the basis of the radius information or an address unit number-contained in the address unit so that the encrypted data can be recorded.

4. The high-density optical disc as set forth in claim 3, wherein the high-density optical disc is a Blu-ray disc-read only memory (BD-ROM).

5. A method for encrypting data and recording the encrypted data on a high-density-optical disc, comprising the steps of:
(a) encrypting data on the basis of disc radius information or an address unit number to be recorded or recorded on the high-density optical disc; and
(b) recording the encrypted data from the disc's outer periphery to the disc's inner periphery on a track of the disc.

6. The method as set forth in claim 5, wherein the disc radius information indicates a distance between the disc's outer periphery and a corresponding position, and is contained and recorded in an address unit.

7. The method as set forth in claim 5, wherein the encrypted data is recorded on the basis of a discontinuous recording format corresponding to a rewritable high-density optical disc.

8. A method for reproducing encrypted data recorded on a high-density optical disc, comprising the steps of:
(a) searching for and reading disc radius information or an address unit number recorded on the high-density optical disc;
(b) decrypting encrypted data on the basis of the disc radius information or address unit number recorded on the high-density optical disc; and
(c) decoding the decrypted data to original signal, and reproducing the original signal.

9. The method as set forth in claim 8, wherein the step (b) is carried out by decrypting the read data using a combination of the disc radius information and address unit number on the basis of a decryption method corresponding to a predetermined encryption method.

10. The method as set forth in claim 8, wherein the step (b) is carried out by decrypting, from an outer periphery of a track of the disc to an inner periphery of the track of the disc, the encrypted data recorded from the outer periphery to the inner periphery within a predetermined data block.
